(19) United States
(12) Patent Application Publication
(10) Pub. No.: US 2018/0330372 A1
(43) Pub. Date: Nov. 15, 2018

(54) CODE, METHODS, AND SYSTEMS FOR MONITORING, AUTHORIZING AND REJECTING ELECTRONIC FINANCIAL TRANSACTIONS AND CREDIT INQUIRIES

(71) Applicant: Shlomo Dadon, Fort Lauderdale, FL (US)

(72) Inventor: Shlomo Dadon, Fort Lauderdale, FL (US)

(21) Appl. No.: 15/979,303

(22) Filed: May 14, 2018

Related U.S. Application Data
(60) Provisional application No. 62/506,022, filed on May 15, 2017.

(51) Int. Cl. G06Q 20/40; G06Q 20/42; G06Q 20/34; G06Q 40/02

(52) U.S. Cl. CPC G06Q 20/401; G06Q 40/02; G06Q 20/34; G06Q 20/42

(57) ABSTRACT

Code, methods, and systems for monitoring, accepting and rejecting financial transactions and credit inquiries associated with a user payment card is disclosed. The system receives user data for a user. The system integrates with a first financial network associated with payment card data of the user such that the first financial network sends a first financial network request for user authorization for each initiated financial transaction. The system determines the customer record associated with the first financial network request. The system displays a first GUI requesting a user approval of the initiated financial transaction associated with the financial network request for user authorization. The system receives first input data from a remote computing device corresponding to a financial transaction authorization message or a financial transaction denial message. The system transmits the first financial network a message denying or accepting the initiated financial transaction.

### CROSS-REFERENCE TO RELATED APPLICATIONS

This application claims the benefit of the filing date of U.S. Provisional Application Ser. No. 62/506,022 titled “SYSTEM FOR MONITORING, ACCEPTING AND REJECTING ELECTRONIC FINANCIAL TRANSACTIONS” and filed May 15, 2017 and the subject matter of which is incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The present invention relates to the field of electronic commerce, and more specifically to field of monitoring electronic financial transactions and credit inquires.

### BACKGROUND

In ancient times, non-financial transactions were commonly conducted through systems of credit, by which goods and services were exchanged for a promise of future compensation. As cities and society developed, coins and other compact forms of specie were minted or printed as flat money with set values, permitting the accumulation of assets that would not deteriorate over time. Today, many financial transactions are completed electronically.

For a credit card transaction to take place, a consumer will first use a credit card at a point of sale. The point of sale machine will capture the credit card information. Next, over a communications network, the merchant, over the communications network, will submit the credit card information for the transaction to a payment gateway. Next, the payment gateway will send to the financial network for approval by the credit card bank, such as American Express. Next, the credit card issuing bank will issue the approval or rejection based upon if the information submitted by the merchant's credit card processor is correct.

One major concern with electronic financial transactions is fraud. It is understood that the term electronic financial transaction or financial transaction refers to EFTs, ACH, credit card transactions, debit card transactions and other financial transactions that are completed through the use of the communications network, such as the Internet. For example, thieves or fraudsters may obtain a consumer's credit card information and other personal data and use such data to complete a financial transaction or purchase an item or service without a person's permission. This can be a major problem for consumers and credit card companies alike. Many merchants and consumers have had major issues with fraudulent financial transactions that occurred without a consumer's permission.

Another major concern with electronic financial transactions or credit card transactions is overspending. In the not so distant past, consumers only form of payment was by cash. With cash, if a person had no more cash in their wallet, then he would know that they had no more money to spend. On the other hand, with credit card transactions, many people spend more than they have because with credit cards a person operates based upon credit and maybe more likely to spend more money than they have more easily. This causes a major financial problem for many people.

Another may issue with financial transactions is that many times individuals may use a person's credit card number or tax identification number to steal a person's identity. A major problem today is identity theft. Many times, a person will try to obtain a loan or other type of contractual obligation based upon a person's credit using another person's identity. Currently, there is no effective way to monitor credit checks or inquiries from the credit bureau so that a person's online identity may be protected. Because there is no effective way to monitor a person's credit before false or fraudulent activity takes place, a person cannot effectively monitor a person's credit.

As a result, there exists a need to more effectively monitor per financial transactions and credit inquiries.

### SUMMARY

A non-transitory computer readable medium storing computer readable program code which when executed on a server is configured for monitoring, accepting and rejecting electronic financial transactions and credit inquires associated with a consumer payment card is disclosed. The code is configured for: (a) receiving from a remote computing device a plurality of user data for a user and storing the user data in a user record in an attached database, the attached database configured for storing a plurality of user records; (b) determining payment card data associated with the user payment card and storing the payment card data in the corresponding user record; (c) integrating with at least a first financial network associated with the payment card data such that at least the first financial network sends a financial network request for user authorization for each initiated financial transaction received by at least the first financial network; (d) receiving, in real time, from at least the first financial network the financial network request for user authorization for each initiated financial transaction from at least the first financial network; (e) determining, in real time, the customer record associated with the financial network request for user authorization received; (f) displaying, in real time, on the remote computing device of the user a first graphical user interface (GUI) requesting a user approval of the initiated financial transaction associated with the financial network request for user authorization; (g) accepting, in real time, a plurality of first input data from the user received at the remote computing device, wherein the first input data corresponds to at least one of a financial transaction authorization message and a financial transaction denial message for the initiated financial transaction; and, (h) transmitting, in real time, to at least the first financial network associated with the financial network request for user authorization received, at least one of the financial transaction authorization message and the financial transaction denial message for the initiated financial transaction.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a diagram of an operating environment that supports code, methods, and systems for monitoring, authorizing and rejecting electronic financial transactions and credit inquiries, according to an example embodiment;

FIG. 2 is a flowchart illustrating the control flow of certain steps of the code, methods, and systems for monitoring, authorizing and rejecting electronic financial transactions and credit inquiries, according to an example embodiment;

FIG. 3 is a diagram of the data flow related to integrating with the financial networks and credit bureaus for code, methods, and systems for monitoring, authorizing and rejecting electronic financial transactions and credit inquiries, according to an example embodiment;

FIG. 4A is a diagram of the data flow related to receiving initiated financial transactions and financial network requests for the code, methods, and systems for monitoring, authorizing and rejecting electronic financial transactions and credit inquiries, according to an example embodiment;

FIG. 4B is a flowchart illustrating the control flow of steps receiving initiated financial transactions and financial network requests for the code, methods, and systems for monitoring, authorizing and rejecting electronic financial transactions and credit inquiries, according to an example embodiment;

FIG. 5A is a diagram of the data flow related to receiving initiated credit inquiries and credit bureau inquiry requests for the code, methods, and systems for monitoring, authorizing and rejecting electronic financial transactions and credit inquiries, according to an example embodiment;

FIG. 5B is a flowchart illustrating the control flow of steps related to initiated credit inquiries and credit bureau inquiry requests for the code, methods, and systems for monitoring, authorizing and rejecting electronic financial transactions and credit inquiries, according to an example embodiment;

FIG. 6A is a diagram of the data flow related to receiving user approval of initiated financial transactions for the code, methods, and systems for monitoring, authorizing and rejecting electronic financial transactions and credit inquiries, according to an example embodiment;

FIG. 6B is a flowchart illustrating the control flow of steps related receiving user approval of initiated financial transactions for the code, methods, and systems for monitoring, authorizing and rejecting electronic financial transactions and credit inquiries, according to an example embodiment;

FIG. 7A is a diagram of the data flow related to receiving user approval of initiated credit inquiries for the code, methods, and systems for monitoring, authorizing and rejecting electronic financial transactions and credit inquiries, according to an example embodiment;

FIG. 7B is a flowchart illustrating the control flow of steps related to receiving user approval of initiated credit inquiries for the code, methods, and systems for monitoring, authorizing and rejecting electronic financial transactions and credit inquiries, according to an example embodiment;

FIG. 8 is a graphical user interface illustrating a geographic user location relative to a geographic transaction location for the code, methods, and systems for monitoring, authorizing and rejecting electronic financial transactions and credit inquiries, according to an example embodiment;

FIG. 9A is a flowchart illustrating the control flow of steps related to receiving data for automatically authorizing and declining initiated financial transactions for the code, methods, and systems for monitoring, authorizing and rejecting electronic financial transactions and credit inquiries, according to an example embodiment;

FIG. 9B, is a graphical user interface for receiving input data for the code, methods, and systems for monitoring, authorizing and rejecting electronic financial transactions and credit inquiries, according to an example embodiment;

FIG. 10 is a graphical user interface displaying a graphical representation of a plurality of initiated financial transactions to be authorized of declined by the user for the code, methods, and systems for monitoring, authorizing and rejecting electronic financial transactions and credit inquiries, according to an example embodiment;

FIG. 11 is a graphical user interface displaying a graphical representation of a plurality of initiated credit inquiries to be authorized or declined by the user for the code, methods, and systems for monitoring, authorizing and rejecting electronic financial transactions and credit inquiries, according to an example embodiment; and,

FIG. 12 is a block diagram of a system including an example computing device and other computing devices.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering, or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system that requires a consumer to accept or reject a financial transaction before the transaction is completed. As a result, a consumer will very easily monitor the financial transactions being completed that could affect a consumer's credit information. Additionally, the system provides an accounting of the completed financial transactions over a period of time so that a person can know more frequently how much money the expense over a period of time. This feature is helpful to facilitate a person not spending more money than a person can afford or should spend. The system also improves over the prior art by providing the ability to accept or reject numerous transactions at one time which may be helpful for commercial purposes or for accounts with multiple users or cards such that a user may monitor multiple cards or transactions. The system also improves over the prior art by providing a graphical display on the remote computing device that includes a geographic user location relative to a geographic transaction location so that a user may more easily determine if the transaction is fraudulent. The system also improves over the prior art by providing an interface for automatically authorizing or denying a transaction based upon a geofence. The system also improves over the prior art by providing a graphical user interface that displays a graphical countdown indicating the remaining time for providing user approval or denial of a transaction. The disclosed embodiments improve upon the problems with the prior art by providing a system that requires a consumer to accept or reject a credit inquiry before the credit inquiry is completed which greatly increases a user's ability to monitor a person's credit history and prevent fraud.

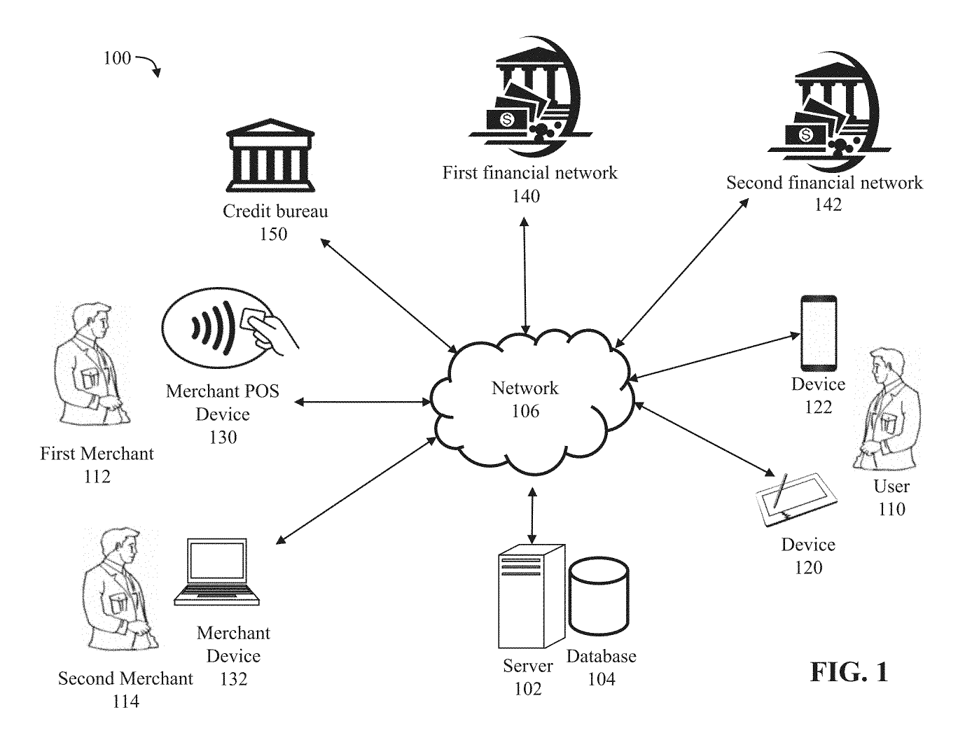

Referring now to the Figures, FIG. 1 is a diagram of an operating environment 100 that supports code, methods, and systems for monitoring, accepting and rejecting electronic financial transactions and credit inquiries, according to an example embodiment. FIG. 1 illustrates a single user 110, a single first merchant 112 and a single second merchant 114 that is connected to and can access the communications network 106 via computing device 120, 122, POS device 130 and device 132, respectively, wherein each device 120, 122, POS device 130 and device 132 may include a mobile computing device, smart phone, mobile phone, handheld computer, laptop, server, workstation, desktop computer, computer terminal, workstation, or the like.

FIG. 1 further shows various components coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Connected to network 106 is server 102, which substantially encompasses the processes code, methods, and systems for monitoring, accepting and rejecting electronic financial transactions and credit inquiries over communications network 106, as described in greater detail below. In one embodiment, data, messages, message responses, inquiries, provided to and from the server 102 are provided via TCP/IP and/or HTTP over network 106. It is understood that the term electronic financial transaction or financial transaction be used interchangeably and may refer to EFTs, ACH, credit card transactions, debit card transactions and other financial transactions that are completed through the use of the communications network, such as the Internet.

Each of the financial networks 140, 142 are also understood to include various nodes or entities within the financial network and may include a payment gateway, merchant credit card processor, acquiring processor, issuing processor, credit card association network, credit card bank, issuing bank or financial institution, acquiring bank, card association involved in allowing the payment of processing of payment using payment cards and the computing devices for communicating over communications network and with device 120, 122, POS device 130 and device 132. It is understood that each of the financial networks may comprise separate entities not separately illustrated in the figures. Each of the nodes, entities or components of the financial network may include a business company (often a third party) appointed by a merchant to handle transactions from various channels such as credit cards and debit cards for merchant acquiring banks.

By way of background, a user begins a payment card transaction by presenting his or her card to a merchant as payment for goods or services. The merchant uses a POS Device, which may be for example a credit card machine, software or gateway, to transmit the cardholder's information and the details of the transaction to the financial network. The acquiring bank (or its processor) associated with the financial network captures the transaction information and routes it through the appropriate card network to the user's issuing bank to be approved or declined. For a Mastercard transaction, for example, information and data is routed between issuing and acquiring banks through MasterCard's network. Visa transactions, for example are routed through Visa's network. The payment card issuer receives the transaction information from the acquiring bank (or its processor) through Banknet or VisaNet and responds by approving or declining the transaction after checking to ensure, among other things, that the transaction information is valid, the cardholder has sufficient balance to make the purchase and that the account is in good standing. The payment card issuer sends a response code back through the appropriate network to the acquiring bank (or its processor). The response code reaches the merchant's terminal, software or gateway and is stored in a batch file awaiting settlement.

The credit bureau 150 are also understood to include separate entities not separately illustrated in the figures and the term credit bureau may include multiple nodes, components or entities. The credit bureau may include any company that collects information relating to the credit ratings of users and makes it available to credit card companies, financial institutions, etc., and computing devices for communicating via communications network 106. The credit bureau may include the credit bureau Equifax, TransUnion, Experian. In operation, businesses and third parties, such as auto loan lenders, banks, credit card companies and insurance agencies, use credit data from the credit bureaus to determine risk level of users. Typically, to run a credit check or credit inquiry, typically a third party or merchant 112, 11 submit via the communications network 106 to a credit bureau 150 a party's name, address, and Social Security number or ITIN (Individual Taxpayer Identification Number). For example, a second merchant 114 may use device 132 for requesting a credit inquiry from the one of the credit bureau.

Also connected to network 106 is merchant POS device 130 that may be operated by merchant 112. The POS device may be a POS machine, such as a credit card or debit card machine, a website, other point of sale devices and systems. In operation, a user presents a payment card, such as a credit card, debit card or other payment card at the terminal. The merchant POS device communicates via the communication network 106 with payment financial network, or various nodes or components therein, for authorization of payment. In the present operating environment, the POS device communicates with the financial network or nodes or components within the financial network requesting user authorization for each initiated financial transaction from at least the first financial network. However, it is understood that the system may be structured such that the POS may request communication from more than one financial networks or components. The code, methods and systems of the present invention integrates with at least a first financial network, or node or component of the financial network associated with the payment card data of a user's credit card such that at least the first financial network sends a financial network request for user authorization for each initiated financial transaction received by at least the first financial network to the system so that the user, in addition to a user's bank may approve an initiated transaction. The system may be configured such that the user authorization may be requested either before or after approval of bank approval associated with the user's credit card.

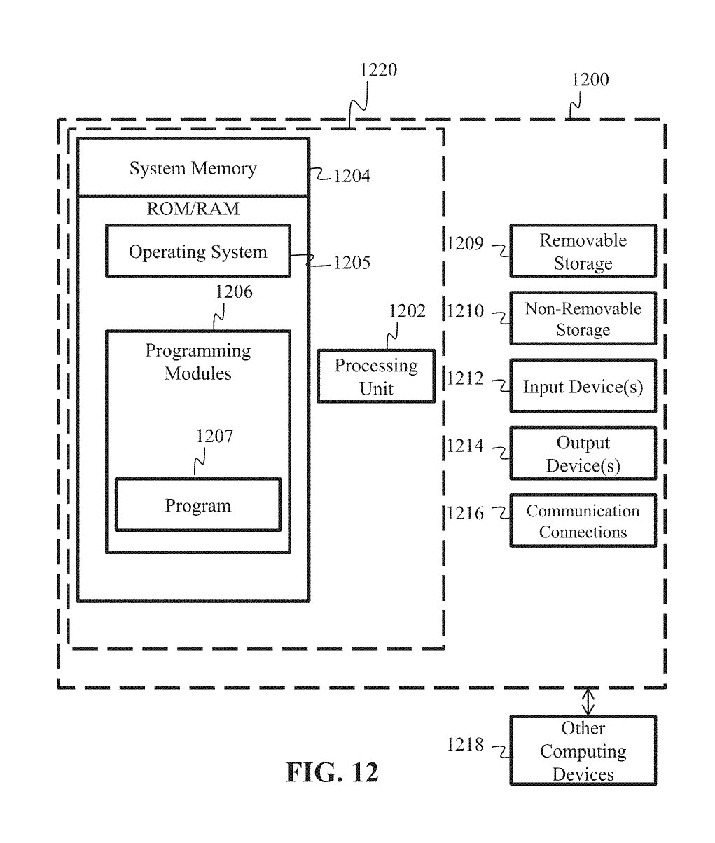

Server 102, devices 122, 120, 132, POS device 130 and first financial network 140 and second financial network 142 and credit bureau 150 may each include a software engine that delivers applications, data, program code and other information to networked computing devices, such as device 122, 120, 132 and POS device 130. Examples of server 102, devices 120, 122, 130, 132 and devices used within financial networks 140, 142 and credit bureau 150 are described in greater detail below with reference to FIG. 12.

FIG. 1 further shows a database or repository 104, which may be a relational database comprising a Structured Query Language (SQL) database stored in a SQL server. The repository 104 serves data from a database, which is a repository for data used by server 102 and device 120, 122, 132, POS device 130, credit bureau 150 and financial networks 140, 142 during the course of operation of the invention. Database 104 may be distributed over one or more nodes or locations that are connected via network 106.

The database 104 may include a plurality of user records, which are records that contain the details of a user 110. A user data 204 of the user record may also include a unique consumer identifier, a user first name, a user second name, payment card data (a user credit card information, a user debit card information, a user bank account information) a user social security number, a user tax identification number, a user mobile number, a user email address and a user physical address, additional contact details, age details, gender details. The user data may include first input data or input including, which includes a financial transaction authorization message and a financial transaction denial message for the initiated financial transaction or other data received or provided by the remote computing device of the user. The user first input data may include an identifier or token that a customer has given the system permission to communicate with his or her credit card processing bank or the third parties. The user data may also include input data including the predetermined radius and protocols for automatically approving transactions (further explained below). The input data may also include data input by the user in predefined fields for receiving user responses to questions for automatically denying or approving a transaction. The input data may also include protocols or procedures for automatically approving a transaction or denying a transaction without the user inputting first user data. For example, the user may input a time range for the system for automatically denying an initiated financial transaction, a radius that defines the maximum distance from the geographic user location that a geographic transaction location may be before the system automatically denies an initiated financial transaction, and a maximum amount of a transaction before the system automatically denies and initiated financial transaction. Additionally, other functions of at least a time of day, an amount of the transaction, and the geographic transaction location may also be used for automatically denying a transaction and transmitting a financial transaction denial message for the initiated financial transaction without receiving first input data from the user.

The user data may also include data defining protocols for automatically approving or denying a transaction. The such protocols a function, or a relationship or expression involving one or more variables, that involves authorizing or denying an initiated transaction and then automatically transmitting either a financial transaction authorization message or a financial transaction denial message for the initiated financial transaction without receiving first input data from the user based upon at least one of the following: a time of day of an initiated transaction, an amount of the transaction, and the point of sale geographic location of an initiated transaction. For example, the user may include in the protocol a minimum amount (i.e., $1.00 USD) for an initiated financial transaction to require approval or first input data from the user, times of the days (for example from 3-5 am EST) that will automatically require approval or first input data from the user within a predetermined amount of time, amounts (i.e., amounts >$20.00) for an initiated transaction that will automatically require approval or first input data from the user within a predetermined amount of time.

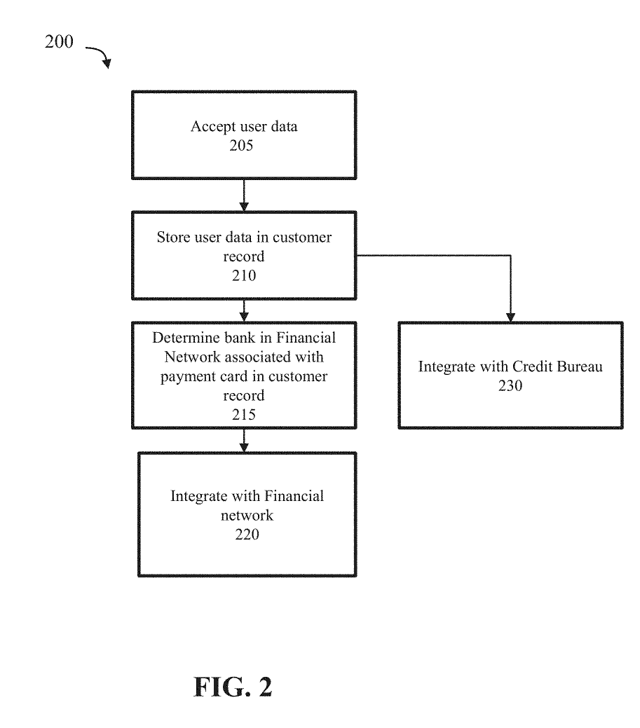

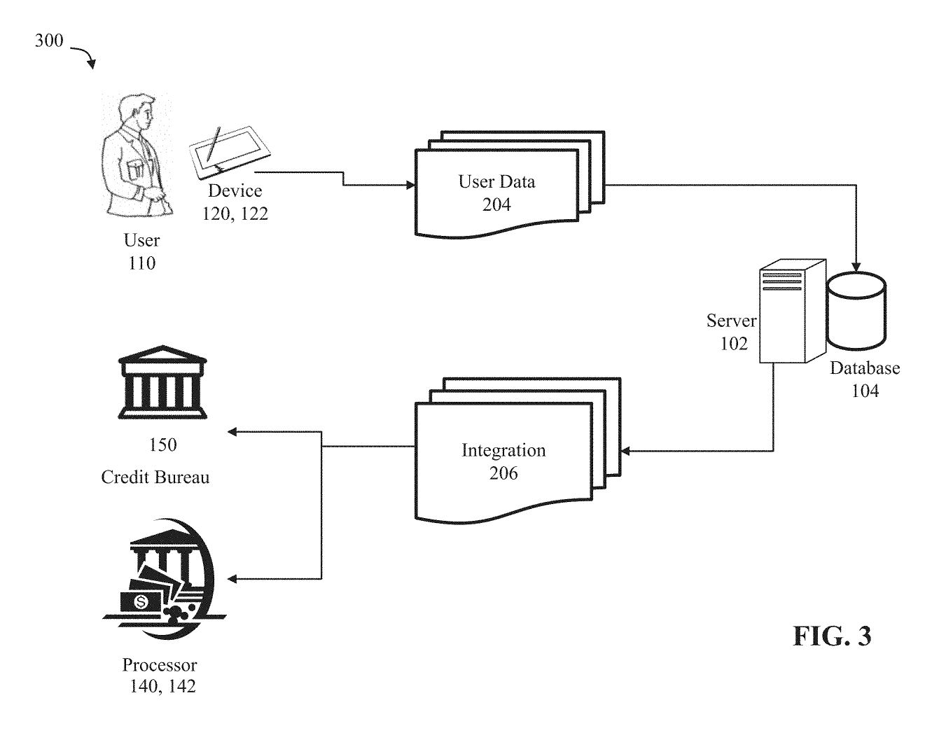

Referring to FIGS. 2 and 3, FIG. 2 is a flowchart 200 illustrating the control flow 200 of certain steps of the system for monitoring, authorizing and rejecting electronic financial transactions and credit inquiries, according to an example embodiment. FIG. 3 is a diagram of the data flow related to integrating with the financial networks and credit bureaus for system for monitoring, authorizing and rejecting electronic financial transactions and credit inquiries, according to an example embodiment. FIG. 2. Illustrates that the user inputs user data 204 into the user interfaces of the devices 120, 122 and the system and code receive the user data. The user interfaces of devices 120, 122 is such that is can accept data as is well known to those skilled in the art. As mentioned above, the user data may include first input data including, which includes a financial transaction authorization message and a financial transaction denial message for the initiated financial transaction. The user first input data may include an identifier or token that a customer has given the system permission to communicate with his or her credit card processing bank or the third parties.

The user data may also include input data or second input data including the predetermined radius and protocols for automatically approving transactions. The input data may also include data input by the user in predefined fields. Such data may include user responses to questions for automatically denying or approving an initiated financial transaction. For example, the user may input times or time ranges for the system for automatically denying an initiated financial transaction, a radius that defines the maximum distance from the geographic user location that a geographic transaction location may be before the system automatically declines or denies an initiated financial transaction, and a maximum amount of a transaction before the system automatically denies or declines to authorize and initiated financial transaction. Additionally, other functions of at least a time of day, an amount of the transaction, and the geographic transaction location may also be used for automatically denying a transaction and transmitting a financial transaction denial message for the initiated financial transaction without receiving first input data from the user. However, other functions may also be used for automatically authorizing or declining initiated transactions and are within the spirit and scope of the present invention.

The user data may also include data protocols for automatically approving or denying a transaction. The such protocols a function, or a relationship or expression involving one or more variables, that involves authorizing or denying an initiated transaction and then automatically transmitting either a financial transaction authorization message or a financial transaction denial message for the initiated financial transaction without receiving first input data from the user based upon at least one of the following: a time of day of an initiated transaction, an amount of the transaction, and the geographic transaction location of an initiated transaction. For example, the user may include in the protocol a minimum amount (i.e, approval not require for amounts less than $1.00 USD) for an initiated financial transaction to require approval or first input data from the user, times of the days (for example from 3-5 am) that will automatically require approval or first input data from the user within a predetermined amount of time, amounts (i.e., amounts >$20.00) for an initiated transaction that will automatically require approval or first input data from the user within a predetermined amount of time. The user data may also include a user approval for the system to interface with the financial network or bank associated with the credit card data.

In step 205, the code is configured for and the system receives from a remote computing device the user data 204 for the remote computing device user 110. Next, in step 210, the code and system are configured for storing the user data received 204 in a user record in an attached database 104. It is understood that the attached database configured for storing a plurality of user records.

Next, in step 215, the code and system are configured for determining the payment card data associated with the user payment card and storing the payment card data in the corresponding user record in the attached database. The payment card data may include a card number, security code, encrypted information, chip data, user first name, user last name, user contact information, expiration date, credit card limit, user authorization information, user signature information, user login or password information, and other information associated with payment cards. The payment card data may include data corresponding to the appropriate financial network, node, component, bank or financial institution that must be integrated with such that at least the first financial network sends a financial network request for user authorization for each initiated financial transaction received by the first financial network. The financial network request may include initiated financial transaction data related to the initiated financial transaction, including user name, credit card number, amount of proposed initiated financial transaction, date of initiated financial transaction, payment card number, merchant name, merchant type, geographic transaction location of the transaction and other information related to the transaction.

Next, in step 220, the code and system are configured to find and integrate with the at least a first financial network associated with the payment card data such that at least the first financial network sends a financial network request for user authorization for each initiated financial transaction received by at least the first financial network. The integration may include integration code, applications, networks or other devices for allowing the system to communicate with the various entities, nodes, components (or computing devices thereof) of the financial network. The integration code 206 may be such that one entity within the financial network may communicate with the code or system of the present invention such that the initiated financial transaction is not approved until a timely response from a financial network request for user authorization is received by the system by at least one node or component within the financial network.

In step 230, the code and system may integrate with at least one credit bureau 150 such that the at least one credit bureau sends a credit bureau request for user authorization for each initiated credit inquiry received by the at least one credit bureau for each of the plurality of users. The integration code 206 may be such that one of the four credit bureaus may communicate with the code or system such that each initiated credit inquiry is not approved until a timely response to the credit bureau request for user authorization received by the system. Steps 210 and 230 may occur simultaneously or sequentially.

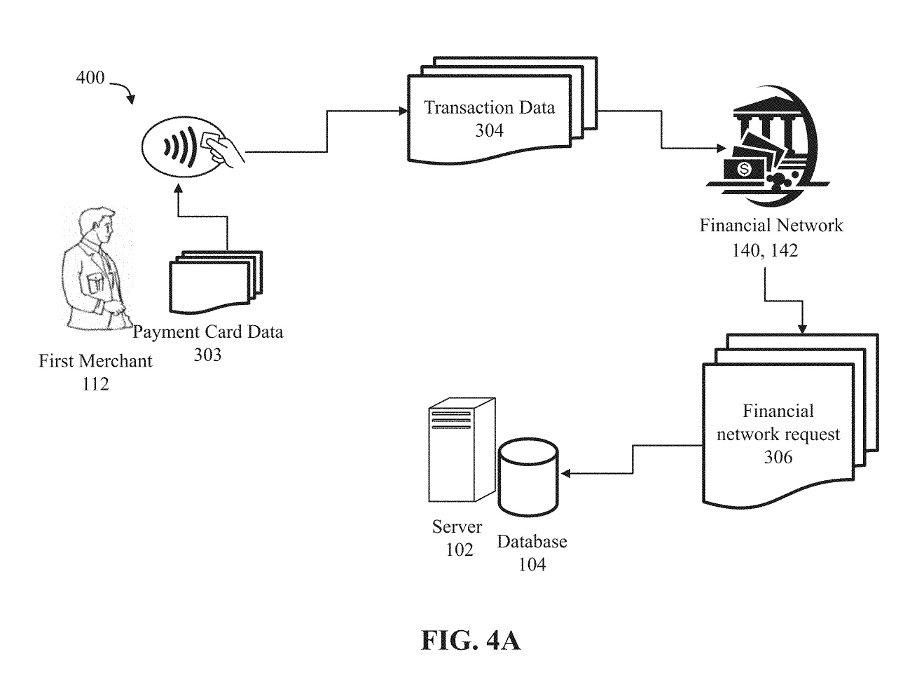

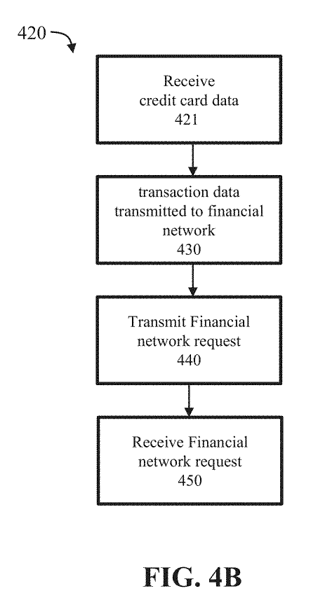

FIGS. 4A and 4B will be discussed together. FIG. 4A is a diagram 400 of the data flow related to receiving initiated financial transaction data and the financial network requests for user authorization for the system for monitoring, accepting and rejecting electronic financial transactions and credit inquiries, according to an example embodiment. FIG. 4B is a flowchart 420 illustrating the process flow of steps related to the approval process for approving initiated financial transactions of the system for monitoring, accepting and rejecting electronic financial transactions, according to an example embodiment. In step 421, the first merchant 112 uses a POS device 130 to acquire the credit card data 303 associated with the credit card. In step 430, the initiated financial transaction data 304, including the amount, time or timestamp data, date, geographic transaction location, user data associated with the payment card number, payment card number, amount of proposed initiated financial transaction, date of initiated financial transaction, payment card number, merchant name, merchant type, financial network data associated with the initiated financial transaction and other information related to the initiated financial transaction is transmitted to at least one of the financial networks 140, 142 or nodes, components or computing devices associated therewith. In step 440, one of the components of the financial network will transmit the financial network request 306 to the system. The financial network request includes a query for authorization by the user including the amount, time or timestamp data, date, geographic transaction location, user data associated with the payment card number, payment card number, amount of proposed initiated financial transaction, date of initiated financial transaction, payment card number, merchant name, merchant type, financial network data associated with the initiated financial transaction and other information related to the initiated financial transaction.

In other embodiments, it is understood that the system may be configured such that after the payment card data 303 is received by the POS device or device receiving the payment card data, then the transaction data 304 may be transmitted to the server 102 first before being transmitted to the financial network. In such embodiments, the code and system are configured to provide authorization or refusal or the initiated financial transaction before questing consumer approval.

Next, in step 450, the system is configured for receiving, in real time, from at least the first financial network the financial network request for user authorization for each initiated financial transaction from at least the first financial network. It is understood that the term real time means that the computing devices update information at the same rate as they receive data. As mentioned above, the financial network request for user authorization may be provided to server 102 via TCP/IP and/or HTTP over network 106. Additionally, the code and system may be configured receiving, in real time, from at least the first financial network a plurality of financial network requests for user authorization for a plurality of initiated financial transactions and subsequently sort using a table lookup the appropriate users associated with each of the initiated financial transactions.

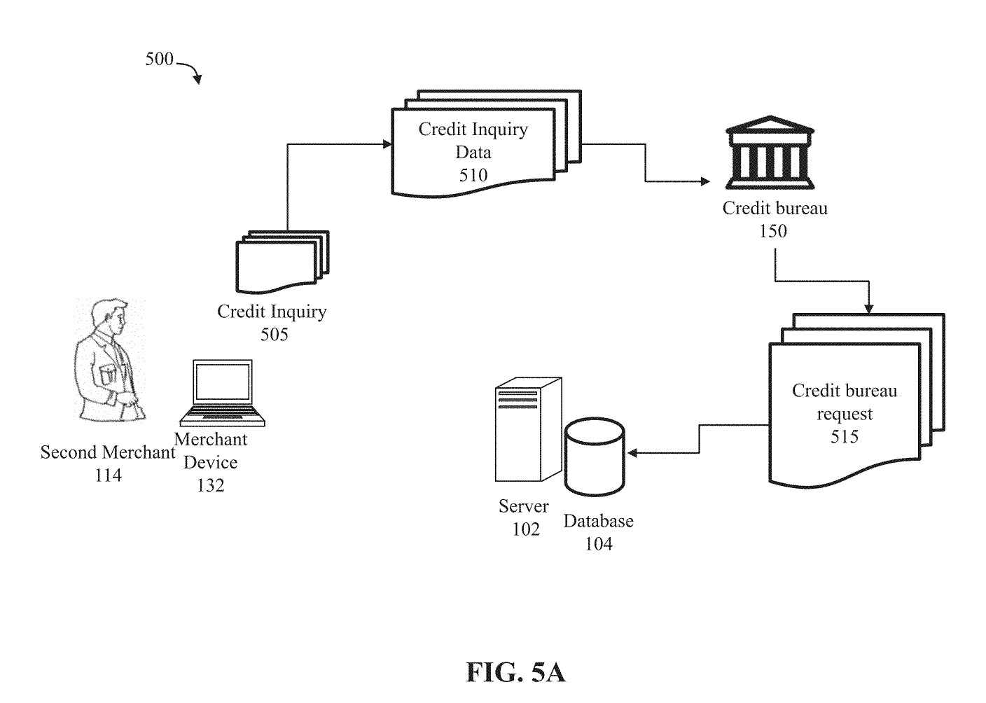

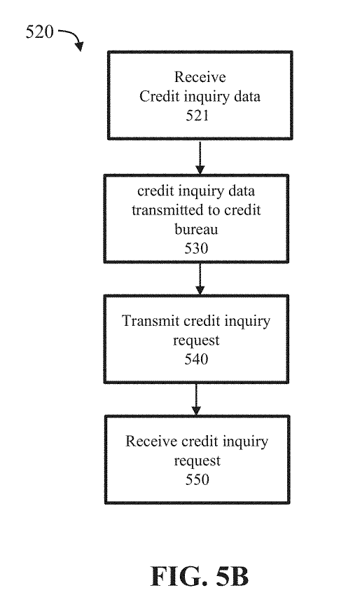

FIGS. 5A and 5B will be discussed together. FIG. 5A is a diagram 500 of the data flow related to credit inquires for the system for monitoring, accepting and rejecting electronic financial transactions and credit inquiries, according to an example embodiment. FIG. 5B is a flowchart 520 illustrating the control flow of steps related to the approval process for approving credit inquiries of the system for monitoring, accepting and rejecting electronic financial transactions, according to an example embodiment. In step 521, the first merchant second merchant 114 enters and the credit inquiry 505 via the merchant device 132, which is received configured for transmitting, over the communications network, as credit inquiry data 510. The credit inquiry may include information that is required for running a credit inquiry by any of the credit bureaus, including a user's first name, user last name, Social Security number or tax identification number, reason for credit inquiry, merchant address, amount of transaction etc. However, it is understood that other data may also be necessary for the credit inquiry. Next, in step 530, the data received by the merchant device 132 is transmitted as credit inquiry data to the credit bureau for providing a response to the credit inquiry. The credit inquiry data may include credit inquiry may include information that is required for running a credit inquiry by any of the credit bureaus, including a user's first name, user last name, Social Security number or tax identification number, reason for credit inquiry, merchant address, amount of transaction etc.

Next, because of the integration mentioned above, in step 540, the credit bureau transmits over the communication network, a credit bureau request for authorization by user. The credit inquiry request may include credit inquiry may include information that is required for running a credit inquiry by any of the credit bureaus, including a user's first name, user last name, Social Security number or tax identification number, reason for credit inquiry, merchant address, amount of transaction etc.

Next, in step 550, the code and system are configured to receive, in real time, over the communications network, from at least one credit bureau the credit bureau request for user authorization for each initiated credit inquiry. However, it is understood that multiple credit bureau inquiry requests may be received from multiple credit agencies.

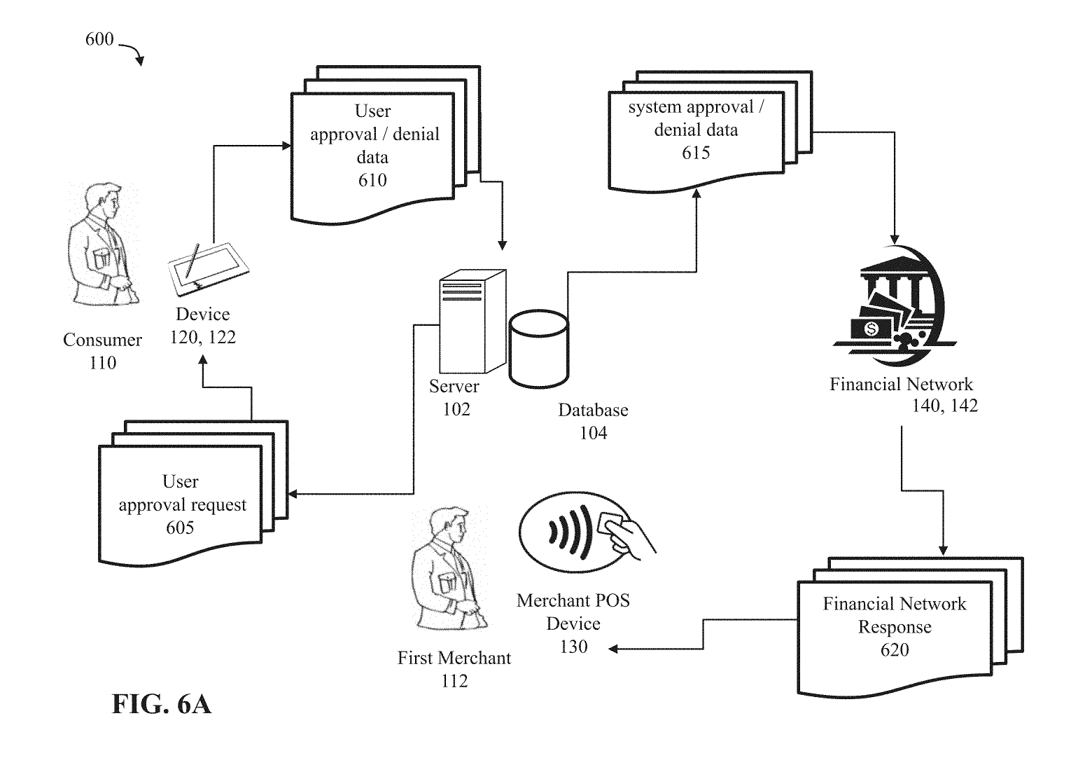

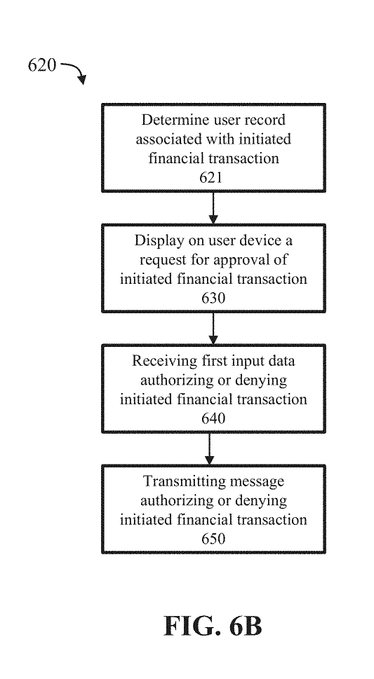

FIGS. 6A and 6B will be discussed together. FIG. 6A is a diagram 600 of the data flow related to receiving user approval of initiated financial transactions for the system for monitoring, accepting and rejecting electronic financial transactions and credit inquiries, according to an example embodiment. FIG. 6B is a flowchart 620 illustrating the control flow of steps related receiving user approval of initiated financial transactions for the system for monitoring, accepting and rejecting electronic financial transactions and credit inquiries, according to an example embodiment. FIGS. 6A and 6B illustrate what the code and system are configured to do after step 450 (in step 450 wherein the system receives the financial network request for user authorization for each initiated financial transaction from at least the first financial network). In operation, in step 621, the system and code are configured for determining, in real time, the user record associated with the financial network request for user authorization received. The system and code may also be configured for compiling, in real time, a plurality of financial network requests for a single user for user authorization for the plurality of initiated financial transactions in a bulk approval manner.

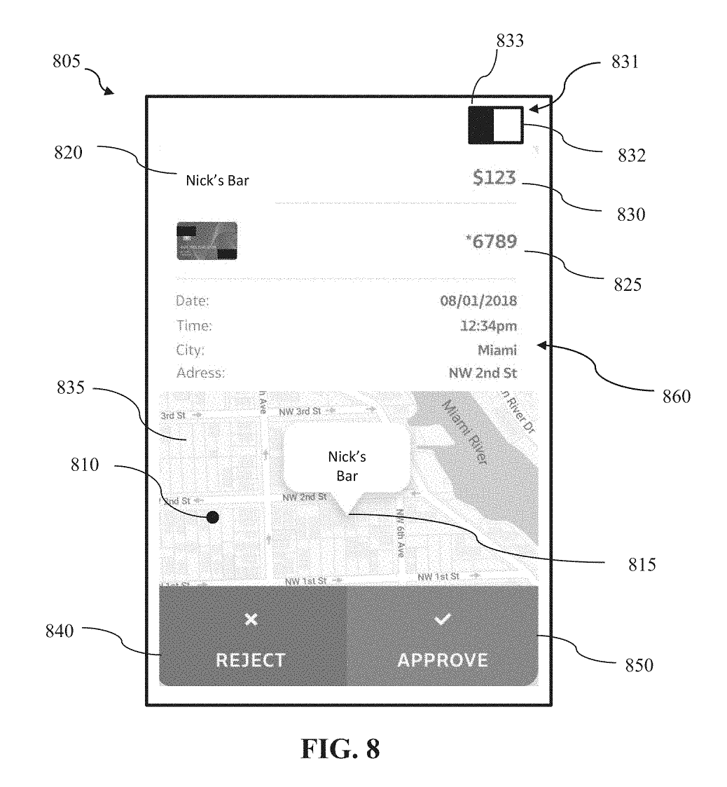

Next, in step 630, the code and system are configured for displaying, in real time, on the remote computing device of the user a graphical user interface (GUI) 605 requesting a user approval of the initiated financial transaction associated with the financial network request for user authorization. Additionally, the code and systems may also also be configured for displaying, in real time, on the remote computing device a list of the plurality of initiated financial transactions for user approval that were compiled for a single user. The graphical user interfaces and graphical representations provided by the system will further be explained below and is illustrated in FIGS. 8, 9B, 10 and 11. Next, in step 640, the code and system are configured for accepting in real time a user approval that may include a plurality of first input data or data 610 from the user received at the remote computing device.

The user approval or the first input data corresponds to at least one of a financial transaction authorization message and a financial transaction denial message for the initiated financial transaction. The first input data may include data and information that corresponds to whether or not a consumer either accepts or declines the transaction. User approval may be provided by providing first input data which may be provided by a click, gesture, button push, swipe, data entry, or any other means by which a user may input data into a remote computing device. The financial transaction denial message may include data that indicates that a user declines authorization of initiated transaction. The transaction authorization message may include data that corresponds to indicating that a user has authorized and initiated transaction. Additionally, the code and system may also be configured for accepting, in real time, a plurality of data from the remote computing device, that corresponds to a bulk financial transaction authorization message and a bulk financial transaction denial message. A bulk financial transaction authorization message may correspond to the user approving multiple transactions by a single input, such as a swipe, click, button push, push of the screen or the type of gesture. Similarly, a bulk financial transaction denial message may correspond to the user declining multiple transactions by a single input, such as a swipe, click, button push, push the screen over the type of gesture.

Next, in step 650, the code and system are configured for transmitting, in real time, to at least the first financial network associated with the financial network request for user authorization received, at least one of the financial transaction authorization message and the financial transaction denial message 615 for the initiated financial transaction. As mentioned above, the system may be configured such that the system may interface with the financial network 140, and 142 at a variety of different nodes within the network. Each node within the financial network may comprise may include a payment gateway, merchant credit card processor, acquiring processor, issuing processor, credit card association network, credit card bank, issuing bank or financial institution, acquiring bank, card association involved in allowing the payment of processing of payment using payment cards. In other words, the code and system are configured for transmitting either the financial transaction authorization message and financial transaction denial message so that the financial network and transit a message for either approving or denying the initiated financial transaction. In certain embodiments, the system and code are configured to transit the financial transaction authorization message and the financial transaction denial message before any node in the financial network approves or denies the initiated financial transaction. In other embodiments, the system and code are configured to transit the financial transaction authorization message and the financial transaction denial message after a node in the financial network approves or denies the initiated financial transaction.

Additionally, the code and system may also be configured for transmitting, in real time, to at least the first financial network associated with the plurality of financial network requests for user authorization for the plurality of initiated financial transactions in at least one of the bulk financial transaction authorization message and the bulk financial transaction denial message.

Additionally, the code and the system are further configured to provide to the remote computing device a notification message including an amount of a completed financial transaction. Additionally, in other embodiments, the code and system are further configured to provide a notification message with an accounting of at least one of the completed financial transactions for a predetermined billing cycle. This allows the user to easily view the amount of view the total amount of money a user has spent during a single billing cycle. The first notification message may be transmitted over the communications network and provided on the display of the remote computing device. Each notification message may include information related to each completed transaction including user name, credit card number, amount of proposed initiated financial transaction, date of initiated financial transaction, payment card number, merchant name, merchant type, geographic transaction location of the transaction and other information related to the transaction. In one embodiment, the notification messages may be provided to and from the server 102 are provided via TCP/IP and/or HTTP over network 106. However other formats be used and are within the spirit and scope of the present invention.

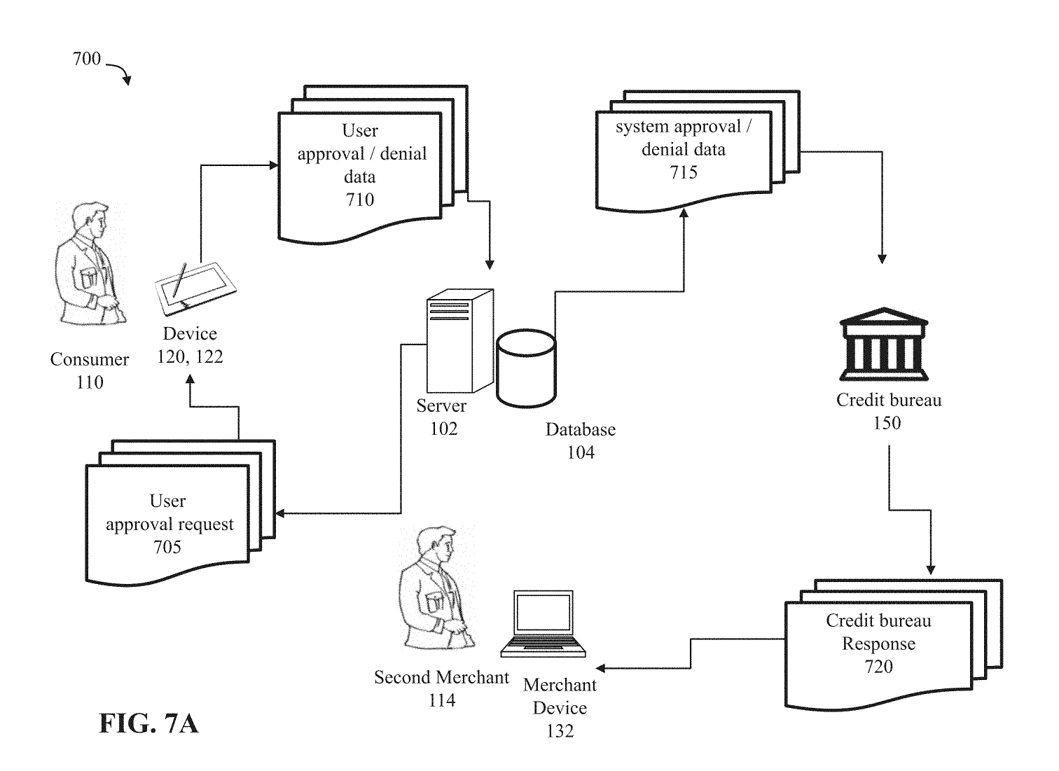

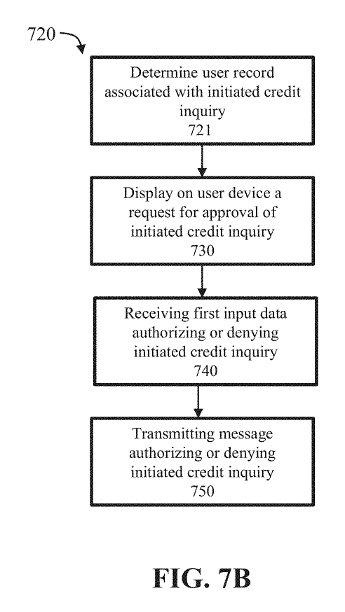

FIGS. 7A and 7B will be discussed together. FIG. 7A is a diagram 700 of the data flow related to receiving user approval of initiated credit inquiries for the system for monitoring, accepting and rejecting electronic financial transactions and credit inquiries, according to an example embodiment. FIG. 7B is a flowchart 720 illustrating the control flow of steps related receiving user approval of initiated credit inquiries for the system for monitoring, accepting and rejecting electronic financial transactions and credit inquiries, according to an example embodiment. After receiving the credit inquiry request from the credit bureau (from step 550 as explained above), in step 721, the system and code is configured for determining, in real time, the user record associated with the credit bureau request for user authorization received. Next, in step 730, the code and system are configured for displaying, in real time, on the remote computing device of the user a GUI 705 requesting the user approval from the remote computing device of the initiated credit inquiry associated with the credit inquiry request for user authorization. Next, in step 740 the code and system are configured for receiving, in real time, a plurality of input data 710 from the remote computing device. The input data corresponds to at least one of a credit inquiry authorization message and a credit inquiry denial message for the credit inquiry. Next, in step 750, the code and system are configured for transmitting, in real time, to at least one credit bureau associated with the credit bureau request 750, at least one of the credit inquiry authorization message and the credit inquiry denial message. In one embodiment, input data in response to (in certain embodiments third input data) the credit bureau requests for user authorization, credit inquiry, messages, credit authorization message, credit inquiry denial message, message responses, inquiries etc. are provided to and from the server 102 are provided via TCP/IP and/or HTTP over network 106. Additionally, in other embodiments for transmitting over the communications network the input data may be used and are within the spirit and scope of the present invention.

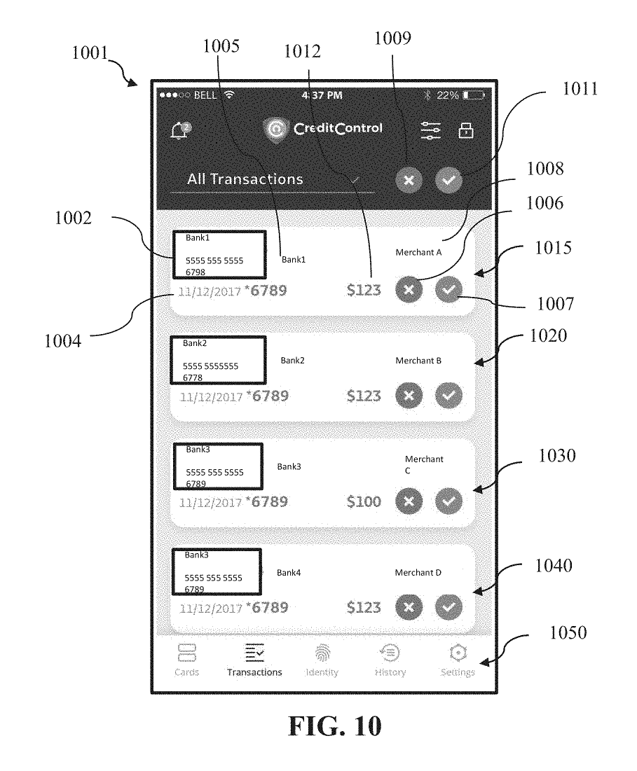

Moving to FIG. 10, FIG. 10 is a graphical user interface 1001 displaying a graphical representation of a plurality of initiated financial transactions to be authorized or declined/denied by the user for the system for monitoring, authorizing and rejecting electronic financial transactions and credit inquiries, according to an example embodiment. As mentioned above, the system is configured for integrating with more than one financial networks. Additionally, the system is also configured for compiling, in real time, multiple network request for user authorization of initiated financial from transactions. This can be an improvement over the prior art because it may allow users having an account having multiple payment cards attached to an account to easily view transactions and approve transactions. Additionally, if multiple transactions are being attempted at one time, it allows for the user to deny or decline numerous transactions at once. Graphical user interface 1001 includes transaction areas 1015, 1020, 1030 and 1040. The transaction areas may be used for graphically illustrating an initiated transaction. In the present embodiment the transaction area easily display the data associated with initiated financial transactions. The transactions areas make it easy for users to view initiated transactions form payment cards. Each transaction area may include a card type 1002. The card type may include a graphical image of the type of card. Additionally, each transactional area may include a graphical representation of bank information 1005. The bank information may include a bank name, such as Bank of America™, Chase™, CITI Bank™ etc. Additionally, a graphical representation of a transaction amount 1012 may also be used. The transactional amount may be a graphical representation of the amount of the transaction. Additionally, the transaction area may include a transaction date or timestamp 1004 illustrating the date of the transaction. Additionally, the transaction area may also include a graphical representation of a time of a transaction. Additionally, the graphical user interface may include a graphical representation of the merchant name 1008 that is requesting approval of the initiated financial transaction. In certain embodiments, the graphical user interface may include a graphical representation of an approval area 1007 and a denying area 1006 for either approving or denying each initiated transaction, respectively. In one embodiment, the graphical representation of the denying is a circular shape body having an X within the circle. In other embodiments, the graphical representation of the approval area is a circle shape body having a check bar within it. However, it is understood that other shapes may also be used and are within the spirit and scope of the present invention. The transaction area is designed to provide a graphical representation of an initiated financial transaction. One improvement over the prior art is that the present invention may allow the user to easily approve or decline multiple transactions at once. The graphical user interface illustrated in FIG. 10 is configured for displaying, in real time, on the display of the remote computing device of the user a list of initiated financial transactions for user approval via input data. Additionally, the graphical user interface may also be configured for receiving input data from the remote computing device that corresponds to a bulk a financial transaction authorization message or a bulk financial transaction denial message. In FIG. 10, a graphical representation of a bulk financial transaction approval area 1011 is illustrated and a graphical representation of a bulk financial transaction denial area 1009 is disclosed. In operation, a user can provide input, using a gesture or click, on the bulk financial transaction denial area to decline or deny multiple initiated financial transactions using a single gesture. A gesture or engagement with the UGI may be a mouse click, a click, gesture, button push, swipe, data entry, or any other means by which a user may input data into a more remote computing device. Additionally, in operation, a user can input, using a gesture or click, on the bulk financial transaction approval area to accept or authorize multiple initiated financial transactions at one time. In operation, the code and system are configured for receiving in real time, from the remote computing device, input data that corresponds to either the bulk financial transaction authorization message or the bulk financial transaction denial message. The input data related to the approval of bulk or multiple initiated financial transactions may be provided to and from the server 102 are provided via TCP/IP and/or HTTP over network 106. Additionally, similar to the other input data that is input by the user and received by the remote computing device, the input data related to the approval and denial of multiple transactions may be input using by a click, gesture, button push, swipe, data entry, or any other means by which a user may input data into a remote computing device.

Next, after receiving the input data related to the authorization or denial of multiple initiated financial transactions, the system and code is configured for transmitting, in real time, to at least the first financial network (or nodes or components thereof) associated with the plurality of financial network request for user authorization for the plurality of initiated financial transactions either the bulk financial transaction authorization message or the bulk financial transaction denial message.

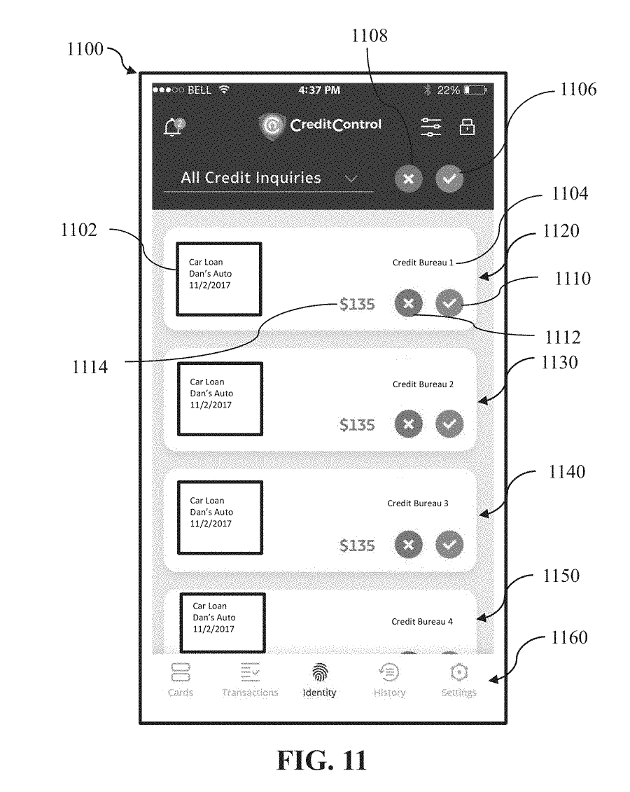

FIG. 11 is a graphical user interface displaying a graphical representation 1100 of a plurality of initiated credit inquiries to be authorized or declined by the user. One of the improvements over the prior art is that the code and system is configured for providing to the remote computing device a graphical presentation of credit inquiries for a user to either accept or approve in real time. As mentioned above, the code and system are configured for integrating with at least one credit bureau such that the at least one credit bureau sends a credit bureau request for user authorization for each initiated credit inquiry received by the at least one credit bureau for each of the plurality of users. The system is also configured for receiving, in real time, over the communications network, from at least one credit bureau the credit bureau request for user authorization for each initiated credit inquiry. In operation, the code and system are configured for determining, in real time, the user record associated with the credit bureau request for user authorization received. In one embodiment, the system may be configured for determining each user record associated with the credit bureau request for user authorization received. The system and code may also be configured to compile, in real time, multiple credit bureau requests for user authorization for multiple credit inquiries for a single user. The system and code are also configured for displaying, in real time, on the remote computing device of the user a graphical representation 1100 for user approval of multiple the initiated credit inquiries associated with the credit inquiry request for user authorization. In one embodiment, each credit inquiry may be displayed in a credit inquiry location 1120, 1130, 1140, 1150 on the GUI. Each of the credit inquiry locations may include credit bureau information 1104. The credit bureau information may include a graphical representation of the credit bureau associated with the credit inquiry request. Additionally, the credit inquiry location may also include a summary 1002 of the purpose of the credit inquiry. For example, in FIG. 11, the graphical representation of the summary includes the date of when the initiated credit inquiry was received by the system, the merchant making the request, and the purpose of the request (car loan, etc.). Additionally, the credit inquiry location may also include a credit inquiry amount 1114 related to the initiated credit inquiry. Additionally, graphical representation for each credit inquiry may also include other data associated with each initiated credit inquiry. Additionally, the graphical representation for each credit inquiry may include an approval area 1110, for receiving a gesture (button push, swipe, data entry, or any other means by which a user may input data into a more remote computing device) which when received approves an individual initiated credit inquiry. Additionally, the graphical representation for each credit inquiry may include a denial area 1112, for receiving a gesture which when received declines an individual initiated credit inquiry. In the present embodiment the approval areas 1110 and denial areas 1112 may be an icon or other image that when engaged with may provide data corresponding to data for denying the credit inquiry and transmitting a credit inquiry denial message.

Additionally, a graphical representation of a bulk credit inquiry approval area 1106 is illustrated and a graphical representation of a bulk credit inquiry denial area 1108 is illustrated in FIG. 11. In operation, a user can provide input, using a gesture or click, on the bulk credit inquiry denial area to decline or deny multiple initiated credit inquiry at once. Additionally, in operation, a user can input, using a gesture or click, on the bulk credit inquiry area to accept or authorize multiple initiated credit inquiry at one time. In operation, the code and system are configured for receiving in real time, from the remote computing device, the input data that corresponds to either the credit inquiry authorization message or the bulk credit inquiry denial message. The input data related to the approval and denial of bulk or multiple the initiated credit inquiry may be provided to and from the server 102 are provided via TCP/IP and/or HTTP over network 106. Additionally, similar to the other data input into the remote computing device, the input data related to the approval and denial of multiple credit inquiries may be input using by a click, gesture, button push, swipe, data entry, or any other means by which a user may input data into a remote computing device. This allows a user to either approve or deny multiple credit inquires at once by a single gesture. In the present embodiment the bulk denial areas may be an icon or other image that when engaged with may provide data corresponding to data for denying the credit inquiry and transmitting a credit inquiry denial message. Similarly, the bulk approval areas of the GUIs may be an icon or other image that when engaged with may provide data corresponding to data for approving the credit inquiry and transmitting a credit inquiry authorization message.

Moving back to FIG. 8 is a graphical user interface (“GUI”) illustrating a graphical representation of geographic user location 810 relative to a geographic transaction location 815 for the system for monitoring, authorizing and rejecting electronic financial transactions and credit inquiries, according to an example embodiment. The GUI is displayed, in real time, on the remote computing device of the user. In one embodiment, the GUI makes it much easier for user to determine whether a transaction is fraudulent or should be either authorizer declined or denied. In the present embodiment, the graphical user interface includes a first portion or icon 840 of the display for receiving first data corresponding to a financial transaction denial message or a second portion or icon 850 for receiving first data corresponding to a financial transaction authorization message. In the present embodiments, the first portion is a rectangular shape feature configured for receiving a touch or gesture. Similarly, the second portion is a retainer shape feature figure for receiving a touch or gesture. Many different types of graphical representation may be used. The consumer may perform a gesture on the remote computing device to either accept or deny the transaction. The gesture may comprise a mouse click, swiping on the display screen, pushing a button, clicking on a screen, etc. Such gestures are well known to those skilled in the art; however, other gestures and means for accepting or denying a request may also be used and are within the spirit and scope of the present invention. By way of another embodiment, if a consumer approves of the transaction, then the consumer may click on a “YES” or “APPROVED” position on the GUI when the consumer knows that the transaction is accurate and not fraudulent. On the other hand, if the consumer does not know of the transaction or believes the transaction is fraudulent, then the consumer may click on a “NO” or “DECLINED” position on the GUI when the consumer knows that the transaction is not accurate and fraudulent. After performing the gesture or providing the first data, the gesture data or user authorization/denial data received by the remote computing device will be transmitted, over the communications network 106, and received or accepted by the system.

The GUI may provide various types of information regarding the transaction for a user to determine if the initiated transaction should be authorized or declined. For example, the graphical GUI may include a merchant name 820, additional transaction information 860, initiated transaction amount 830 and payment card information 825 (information that may be displayed may include the amount, time or timestamp data, date, geographic transaction location, user data associated with the payment card number, payment card number, amount of proposed initiated financial transaction, date of initiated financial transaction, payment card number, merchant name, merchant type, financial network data associated with the initiated financial transaction and other information related to the initiated financial transaction). However, it is understood that other information may be included. One inventive feature is that the GUI includes a graphical representation of a map 835 having a graphical representation of the geographic user location 840 relative to the graphical representation geographic transaction location of where initiated financial transaction was initiated.

In one embodiment, geographic user location corresponds to the remote computing device geographic location when the financial network request for user authorization for each initiated financial transaction is received by the server. For example, if a user remote computing device is located in Miami, Fla. when the financial network request for user authorization is received by the system or server, then the code is configured for displaying a graphical representation of the geographic location of the remote computing device (as illustrated as 810 in FIG. 8) located on the map. The geographic location of the remote computing device may be determined from a sensor or position locating element within the remote computing device comprise technology such as GPS transceiver, GPS technology, a wireless communication element, such as WIFI, Bluetooth, NFC etc. In other embodiments, the geographic user location may be determined based upon the IP address of a device or remote computing device of the user.

Similarly, geographic transaction location is the geographic location of the point-of-sale device or other device that initiated the initiated financial transaction. In one embodiment, the geographic transaction location may be determined when the financial network request for user authorization for each financial transaction is received by the server from a sensor or position locating element within the remote computing device comprise technology such as GPS transceiver, GPS technology, a wireless communication element, such as WIFI, Bluetooth, NFC etc. In other embodiments, the geographic transaction location may be determined based upon the IP address of a device or remote computing device initiating the financial transaction received by the server. However, it is understood points in time of when the initiated financial transaction is received may also be used and is within the spirit and scope of the present invention.

As illustrated in FIG. 8, the graphical representation of a map 835 having the geographic user location 810 relative to the geographic transaction location makes it extremely easy for a user to visually determine whether or not a user-initiated transaction. In the example illustrated in FIG. 8, the geographic user location 810 is different than the geographic transaction location, which may mean that the user is in a different location than the initiated transaction. As a result, a user can easily determine initiated transaction should be authorized or declined or rejected.

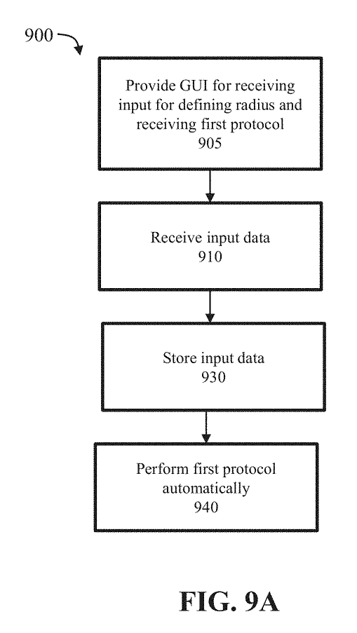

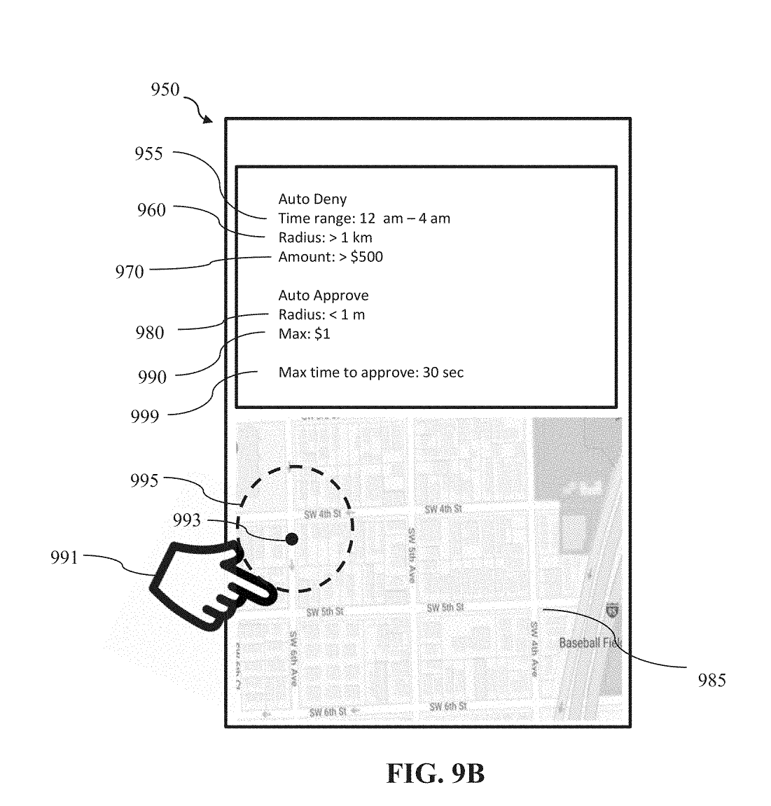

FIG. 9A is a flowchart 900 illustrating the control flow of steps related to receiving approval data or second input data for automatically authorizing and declining transactions for the system for monitoring, authorizing and rejecting electronic financial transactions and credit inquiries, according to an example embodiment. FIG. 9B is a graphical user interface for receiving input data for monitoring, authorizing and rejecting electronic financial transactions and credit inquiries, according to an example embodiment. In one embodiment, the code and system further are configured for determining if a geographic transaction location for each initiated financial transaction is received outside a predetermined radius. In one embodiment, as illustrated in step 905, a GUI may be provided to the remote computing device of the user during the setup phase of the system. The GUI may be configured for receiving user input data defining a predetermined radius and receiving a first protocol for automatically transmitting at least one of the financial transaction authorization message and the financial transaction denial message without receiving first input data from the user. As mentioned above, the first input data may include data and information that corresponds to whether or not a consumer either accepts or declines the transaction. The first input data may be initiated by a click, gesture, button push, swipe, data entry, or any other means by which a user may input data into a more remote computing device. Additionally, input data may be input into GUI using characters, numbers, letters, symbols or other items.

Similarly, the second input data, may be initiated by a click, gesture, button push, swipe, data entry, or any other means by which a user may input data into a more remote computing device. Input data by a click, gesture, button push, swipe, data entry, or any other means by which a user may input data into a more remote computing device. Additionally, input data may be input into GUI using characters, numbers, letters, symbols or other items.

In step 910, the code and system are configured for receiving form the remote computing device input data. FIG. 9B illustrates a GUI having been provided with information from the user. For example, the second input data may be included in predefined fields for receiving user responses to questions for automatically denying or approving a transaction.

Protocols or procedures for automatically approving a transaction or denying a transaction without the user inputting first user data may be included as second input data, input data or protocol data. For example, the user may input a time range 955 for the system for automatically denying an initiated financial transaction, a radius 960 that defines the maximum distance from the geographic user location 993 that a geographic transaction location may be before the system automatically denies an initiated financial transaction, and a maximum amount 970 of a transaction before the system automatically denies and initiated financial transaction. Additionally, other functions of at least a time of day, an amount of the transaction, and the geographic transaction location may also be used for automatically denying a transaction and transmitting a financial transaction denial message for the initiated financial transaction without receiving first input data or approval data from the user.

Additionally, the code and system may also be configured such that in the setup phase, the user can provide a maximum amount of time within which the first input data must be received. In other words, the user may adjust the amount of time within which the first input data or approval must be provided via the remote computing device of the user or the transaction will automatically be denied. If the first input data is not received within that predetermined amount of time, then the initiated financial transaction would be denied. For example, in FIG. 9B, the maximum amount of time for the user to approve or deny the transaction 999 however is 30 seconds. However, it is also understood that the user may adjust the maximum amount of time within which the user must approve or deny the transaction. In operation, if a user approves the initiated financial transaction within that maximum amount of time 999, then the transaction would be approved. However, if the user does not provide the first input data within that maximum amount of time, then the system or code would automatically deny the transaction. This feature is inventive because it now provides an additional layer of protection.

Additionally, the GUI may also be used for receiving data defining the protocols for automatically approving transactions. For example, a user may input a distance that defines a maximum distance from the geographic user location 993 that a geographic transaction location must be less than for the system to automatically approve an initiated financial transaction, and a maximum amount 999 that an initiated financial transaction must be less than for the system otherwise the code and system is configured for automatically denying and initiated financial transaction. Additionally, other functions of at least a time of day, an amount of the transaction, and the geographic transaction location may also be used for automatically authorizing a transaction and transmitting a financial transaction authorization message for the initiated financial transaction without receiving first input data from the user. Next, in step 930, the system and code are configured for storing the second input data defining the protocols for automatically authorizing or automatically declining the initiated financial transaction without receiving first input data or approval data from the user.

Next, in step 940, the code and the system is configured such that after receiving the financial network request for user authorization for the initiated transaction and without receiving first input data, in real time, the system performs the first protocol associated with the initiated transaction and automatically transmits to the first financial network associated with the financial network request for user authorization received, either the financial transaction authorization message and the financial transaction denial message based upon the first protocol.

For example, in operation, if a user inputs during the setup phase that the system may automatically approve an initiated financial transaction that has a geographic transaction location less than 1 m away from the geographic user location, then the system is configured to automatically approve the transaction without receiving first user input data or approval if a transaction is received that has a geographic transaction location less than 1 m away from the geographic user location. By way of another example, in operation if a user inputs during the setup phase that the system may automatically approve a transaction that is less than $1, then the system is configured to automatically approve the transaction if it is less than $1 without receiving first user input data or approval. In operation, if protocol provides that a transaction shed automatically approved, then the system will transmit, in real time, the message authorizing the initiated financial transaction (step 650) for set the financial network can approve the transaction so that the merchant can process the payment and the user may receive the goods and services.

By way of another example, in operation, if a user inputs during the setup phase that the system may automatically deny an initiated financial transaction that has a geographic transaction location greater than 1 km away from the geographic user location, then the system is configured to determine if the geographic transaction location for the initiated financial transaction is outside the predetermined radius and then automatically deny the transaction without receiving first user input data or approval data if a transaction is received having a geographic transaction location greater than 1 km away from the geographic user location. This feature may be critical for users having dependent users associated with the credit card. By way of example, a parent may set a geographical area in which the credit card may be used by a child.

As illustrated in FIG. 9B, the GUI for receiving the second input data may also be configured for the user to define a radius 995 using a gesture such as a pinch or swipe. In one embodiment, the code and system are configured for providing a display configured for illustrating the geographic user location 993 on a graphical representation of a map 985. In the present embodiment, the geographic user location is represented by a dot. However, other shapes and symbols may also be used and are within the spirit and scope of the present invention for the graphical representation of the geographic user location that corresponds to the remote computing device geographic location when the financial network request for user authorization for each initiated financial transaction is received by the server.

In the present embodiment, the radius 995 is defined by a hashed circle. However, it is understood that other shapes and symbols may also be used for defining the radius. It is understood that the radius corresponds to a graphical representation of a predefined radius that may be used for determining if the initiated financial transaction may be either authorized or declined. For example, in operation, a user may perform gestures on the graphical user interface defining a radius of 1 km around a user's geographic user location (as illustrated in FIG. 9B). The code and system are further configured for determining if a geographic transaction location for each initiated financial transaction is received outside or within the predetermined radius. Next, the second data input comprising the gesture data that includes the predetermined radius may be stored in the corresponding user record. Next, after receiving the financial network request for user authorization for the initiated financial transaction and without receiving first input data, in real time, the system will determine if the geographic transaction location for each initiated financial transaction is received outside a predetermined radius and automatically transmit to the associated financial network either a financial transaction authorization message or a financial transaction denial message.

In one embodiment, the code and system our configured to provide a predetermined amount of time for user to provide, via the remote computing device, the first input data. This allows an additional layer of protection in that if a user does not approve or deny and initiated financial transaction within a certain amount of time, then the system and code is configured to automatically deny the initiated transaction. In one embodiment of the code and system are configured such that the GUI includes a graphical countdown indicating remaining time for providing the first input data after the user approval request message has been transmitted to the remote computing device. FIG. 8 illustrates one embodiment of the graphical countdown 831. In FIG. 8, the graphical representation of the countdown includes a rectangular shaped box 832 having a darkened section 833 positioned within the rectangular shaped box that gradually decreases in size as the amount of time remaining to provide the first input data decreases. However, other embodiments of graphical representations of a countdown may be used and are within the spirit and scope of the present invention. For example, an egg timer graphical representation may be used that provides a visual display of how much time is remaining. By way of another example, a countdown displaying digits that represent the amount of time remaining to first input that data may also be used.

FIG. 12 is a block diagram of a system including an example computing device 1200 and other computing devices. Consistent with the embodiments described herein, the aforementioned actions performed by devices 102, 120, 122, 130, 132 140, 142, 150 may be implemented in a computing device, such as the computing device 1200 of FIG. 12. Any suitable combination of hardware, software, or firmware may be used to implement the computing device 1200. The aforementioned system, device, and processors are examples and other systems, devices, and processors may comprise the aforementioned computing device. Furthermore, computing device 1200 may comprise an operating environment for the methods 200, 420, 520, 620, 720, and 900 for implementing operation of the data flow illustrated in 300, 400, 520, 620, 720, and 900 and for providing GUIs 805, 950, 1001 and 1100 for shown in FIGS. 1-11 above.

With reference to FIG. 12, a system consistent with an embodiment of the invention may include a plurality of computing devices, such as computing device 1200. In a basic configuration, computing device 1200 may include at least one processing unit 1202 and a system memory 1204. Depending on the configuration and type of computing device, system memory 1204 may comprise, but is not limited to, volatile (e.g. random access memory (RAM)), non-volatile (e.g. read-only memory (ROM)), flash memory, or any combination or memory. System memory 1204 may include operating system 1205, one or more programming modules 1206 (such as program module 407). Operating system 1205, for example, may be suitable for controlling computing device 1200's operation. In one embodiment, programming modules 1206 may include, for example, a program module 1207. Furthermore, embodiments of the invention may be practiced in conjunction with a graphics library, other operating systems, or any other application program and is not limited to any particular application or system. This basic configuration is illustrated in FIG. 12 by those components within a dashed line 1220.

Computing device 1200 may have additional features or functionality. For example, computing device 1200 may also include additional data storage devices (removable and/or non-removable) such as, for example, magnetic disks, optical disks, or tape. Such additional storage is illustrated in FIG. 12 by a removable storage 1209 and a non-removable storage 1210. Computer storage media may include volatile and nonvolatile, removable and non-removable media implemented in any method or technology for storage of information, such as computer readable instructions, data structures, program modules, or other data. System memory 1204, removable storage 1209, and non-removable storage 1210 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1200. Any such computer storage media may be part of device 1200. Computing device 1200 may also have input device(s) 1212 such as a keyboard, a mouse, a pen, a sound input device, a camera, a touch input device, etc. Output device(s) 1214 such as a display, speakers, a printer, etc. may also be included. The aforementioned devices are only examples, and other devices may be added or substituted.

Computing device 1200 may also contain a communication connection 1216 that may allow device 1200 to communicate with other computing devices 1218, such as over a network in a distributed computing environment, for example, an intranet or the Internet. Communication connection 1216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 1204, including operating system 1205. While executing on processing unit 1202, programming modules 1206 may perform processes including, for example, one or more of the methods 200, 420, 520, 620, 720, and 900 for implementing operation of the data flow illustrated in 300, 400, 520, 620, 720, and 900 and for providing GUIs 805, 950, 1001 and 1100 illustrated in FIGS. 1-11 above. The aforementioned processes are examples, and processing unit 1202 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A non-transitory computer readable medium storing computer readable program code which when executed on a server is configured for monitoring, authorizing and rejecting electronic financial transactions associated with a user payment card comprising:
receiving from a remote computing device a plurality of user data for a user and storing the user data in a user record in an attached database, the attached database configured for storing a plurality of user records;
determining payment card data associated with the user payment card and storing the payment card data in the corresponding user record;
integrating with at least a first financial network associated with the payment card data such that at least the first financial network sends a financial network request for user authorization for each initiated financial transaction received by at least the first financial network;
receiving, in real time, from at least the first financial network the financial network request for user authorization for each initiated financial transaction from at least the first financial network;
determining, in real time, the user record associated with the financial network request for user authorization received;
displaying, in real time, on the remote computing device of the user a first graphical user interface (GUI) requesting a user approval of the initiated financial transaction associated with the financial network request for user authorization;
receiving in real time a plurality of first input data from the user received at the remote computing device, wherein the first input data corresponds to at least one of a financial transaction authorization message and a financial transaction denial message for the initiated financial transaction; and,
transmitting, in real time, to at least the first financial network associated with the financial network request for user authorization received, at least one of the financial transaction authorization message and the financial transaction denial message for the initiated financial transaction.

2. The non-transitory computer readable medium of claim 1, wherein the first GUI includes a graphical representation of a geographic user location relative to a geographic transaction location.

3. The non-transitory computer readable medium of claim 1, wherein the geographic user location corresponds to the remote computing device geographic location when the financial network request for user authorization for each initiated financial transaction is received by the server.

4. The non-transitory computer readable medium of claim 1, wherein computer readable program code is further configured for determining if a geographic transaction location for each initiated financial transaction is received outside a predetermined radius.

5. The non-transitory computer readable medium of claim 4, wherein computer readable program code is further configured for:
providing a second GUI for receiving from the remote computing device second input data defining the predetermined radius and first protocol for automatically transmitting at least one of the financial transaction authorization message and the financial transaction denial message without receiving first input data from the user;
receiving from the remote computing device second input data;
storing the second input data and the first protocol in the corresponding user record; and,
after receiving the financial network request for user authorization for the initiated financial transaction and without receiving first input data, in real time, determining if the geographic transaction location for each initiated financial transaction is received outside the predetermined radius and automatically transmitting to at least the first financial network associated with the financial network request for user authorization received, at least one of the financial transaction authorization message and the financial transaction denial message.

6. The non-transitory computer readable medium of claim 1, wherein code is configured to give a predetermined amount of time for providing the first input data on the remote computing device, and wherein if the first input data is not received within the predetermined amount of time the initiated financial transaction is denied.

7. The non-transitory computer readable medium of claim 6, wherein the first GUI includes a graphical countdown indicating remaining time for providing the first input data after the user approval request message has been transmitted to the remote computing device.

8. The non-transitory computer readable medium of claim 1, wherein the program code is further configured for:
integrating with at least one credit bureau such that the at least one credit bureau sends a credit bureau request for user authorization for each initiated credit inquiry received by the at least one credit bureau for each of the plurality of users;
receiving, in real time, over the communications network, from at least one credit bureau the credit bureau request for user authorization for each initiated credit inquiry;
determining, in real time, the user record associated with the credit bureau request for user authorization received;
displaying, in real time, on the remote computing device of the user a second GUI requesting the user approval of the initiated credit inquiry associated with the credit inquiry request for user authorization;
receiving, in real time, a plurality of second input data from the remote computing device, wherein the second input data corresponds to at least one of a credit inquiry authorization message and a credit inquiry denial message for the credit inquiry; and,
transmitting, in real time, to at least one credit bureau associated with the credit bureau request, at least one of the credit inquiry authorization message and the credit inquiry denial message.

9. The non-transitory computer readable medium of claim 1, wherein the program code is further configured for:
receiving, in real time, from at least the first financial network a plurality of financial network requests for user authorization for a plurality of initiated financial transactions;
compiling, in real time, the plurality of financial network requests for user authorization for the plurality of initiated financial transactions;
displaying, in real time, on the remote computing device of the user a second GUI a list of the plurality of initiated financial transactions for user approval;
receiving, in real time, a plurality of second input data from the remote computing device, wherein the second input data corresponds to at least one of a bulk financial transaction authorization message and a bulk financial transaction denial message; and,
transmitting, in real time, to at least the first financial network associated with the plurality of financial network requests for user authorization for the plurality of initiated financial transactions at least one of the bulk financial transaction authorization message and the bulk financial transaction denial message

10. The non-transitory computer readable medium of claim 1, wherein user data comprises at least a combination of a user first name, a user second name, a user credit card information, a user debit card information, a user bank account information, a user social security number, a user tax identification number, a user mobile number, a user email address and a user physical address.

11. The non-transitory computer readable medium of claim 1, wherein computer readable program code is further configured for:
providing a second GUI for receiving from the remote computing device second input data, wherein the second input data includes a function of at least one of a time of day, an amount of the transaction, and the geographic transaction location for automatically transmitting at least one of the financial transaction authorization message and the financial transaction denial message for the initiated financial transaction without receiving first input data from the user;
receiving from the remote computing device second input data;
storing the second input data in the corresponding user record; and,
after receiving the financial network request for user authorization for the initiated financial transaction and without receiving first input data, in real time, automatically transmitting to at least the first financial network associated with the financial network request for user authorization received, at least one of the financial transaction authorization message and the financial transaction denial message based upon the first protocol.

12. A system, over a communications network, monitoring, authorizing and rejecting electronic financial transactions associated with a user payment card comprising:
a database for storing a user record for each of a plurality of users;
a memory; and,
a processor configured for:
receiving from a remote computing device a plurality of user data for each user and storing the user data in a corresponding user record in the attached database, wherein the user data includes a predetermined radius and first protocol for automatically transmitting at least one of a financial transaction authorization message and a financial transaction denial message without receiving a first input data from the user;
determining payment card data associated with the user payment card and storing the payment card data in the corresponding user record;
integrating with at least a first financial network associated with the payment card data such that at least the first financial network sends a financial network request for user authorization for each initiated financial transaction received by at least the first financial network;
receiving, in real time, from at least the first financial network the financial network request for user authorization for each initiated financial transaction from at least the first financial network;
determining, in real time, the user record associated with the financial network request for user authorization received;
displaying, in real time, on the remote computing device of the user a first graphical user interface (GUI) requesting a user approval of the initiated financial transaction associated with the financial network request for user authorization;
receiving, in real time, the first input data from the user received at the remote computing device, wherein the first input data corresponds to at least one of the financial transaction authorization message and the financial transaction denial message for the initiated financial transaction;
transmitting, in real time, to at least the first financial network associated with the financial network request for user authorization received, at least one of the financial transaction authorization message and the financial transaction denial message for the initiated financial transaction; and,
after receiving the financial network request for user authorization for the initiated financial transaction and without receiving the first input data, in real time, determining if a geographic transaction location for each initiated financial transaction is received outside the predetermined radius and automatically transmitting to at least the first financial network associated with the financial network request for user authorization received, at least one of the financial transaction authorization message and the financial transaction denial message.

13. The system of claim 12, wherein the processor is further configured to give a predetermined amount of time for providing the first input data on the remote computing device, and wherein if the first input data is not received within the predetermined amount of time the initiated financial transaction is denied.

14. The system of claim 13, wherein the processor is further configured to such that the first GUI includes a graphical countdown indicating remaining time for providing the first input data after the user approval request message has been transmitted to the remote computing device.

15. The system of claim 12, wherein the processor is further configured for:
integrating with at least one credit bureau such that the at least one credit bureau sends a credit bureau request for user authorization for each initiated credit inquiry received by the at least one credit bureau for each of the plurality of users;
receiving, in real time, over the communications network, from at least one credit bureau the credit bureau request for user authorization for each initiated credit inquiry;
determining, in real time, the user record associated with the credit bureau request for user authorization received;
displaying, in real time, on the remote computing device of the user a second GUI requesting the user approval of the initiated credit inquiry associated with the credit inquiry request for user authorization;
receiving, in real time, a plurality of second input data from the remote computing device, wherein the second input data corresponds to at least one of a credit inquiry authorization message and a credit inquiry denial message for the credit inquiry; and,
transmitting, in real time, to at least one credit bureau associated with the credit bureau request, at least one of the credit inquiry authorization message and the credit inquiry denial message.

16. The system of claim 12, wherein the processor is further configured for:
providing a second GUI for receiving from the remote computing device second input data, wherein the second input data includes a function of at least one of a time of day, an amount of the transaction, and the geographic transaction location for automatically transmitting at least one of the financial transaction authorization message and the financial transaction denial message for the initiated financial transaction without receiving first input data from the user;
receiving from the remote computing device second input data;
storing the second input data in the corresponding user record; and,
after receiving the financial network request for user authorization for the initiated financial transaction and without receiving first input data, in real time, automatically transmitting to at least the first financial network associated with the financial network request for user authorization received, at least one of the financial transaction authorization message and the financial transaction denial message based upon the initiated financial transaction.

17. A method for monitoring, authorizing and rejecting electronic financial transactions associated with a user payment card comprising:
receiving from a remote computing device a plurality of user data for a user and storing the user data in a user record in an attached database, the attached database configured for storing a plurality of user records, wherein the user record includes a predetermined radius and first protocol for automatically transmitting at least one of a financial transaction authorization message and a financial transaction denial message;
determining payment card data associated with the user payment card and storing the payment card data in the corresponding user record;
integrating with at least a first financial network associated with the payment card data such that at least the first financial network sends a financial network request for user authorization for each initiated financial transaction received by at least the first financial network;
receiving, in real time, from at least the first financial network the financial network request for user authorization for each initiated financial transaction from at least the first financial network;
determining, in real time, the user record associated with the financial network request for user authorization received;
displaying, in real time, on the remote computing device of the user a first graphical user interface (GUI) requesting a user approval of the initiated financial transaction associated with the financial network request for user authorization;
receiving, in real time, a plurality of first input data from the user received at the remote computing device, wherein the first input data corresponds to at least one of the financial transaction authorization message and the financial transaction denial message for the initiated financial transaction;
transmitting, in real time, to at least the first financial network associated with the financial network request for user authorization received, at least one of the financial transaction authorization message and the financial transaction denial message for the initiated financial transaction; and,
after receiving the financial network request for user authorization for the initiated financial transaction and without receiving first input data, in real time, determining if a geographic transaction location for each initiated financial transaction is received outside the predetermined radius and automatically transmitting to at least the first financial network associated with the financial network request for user authorization received, at least one of the financial transaction authorization message and the financial transaction denial message based upon the first protocol.

18. The method of claim 17, wherein the method is further configured to give a predetermined amount of time for providing the first input data on the remote computing device, and wherein if the first input data is not received within the predetermined amount of time the initiated financial transaction is denied.

19. The method of claim 18, wherein the method is further configured such that the first GUI includes a graphical countdown indicating remaining time for providing the first input data after the user approval request message has been transmitted to the remote computing device.

20. The method of claim 17, wherein the method is further configured for:
integrating with at least one credit bureau such that the at least one credit bureau sends a credit bureau request for user authorization for each initiated credit inquiry received by the at least one credit bureau for each of the plurality of users;
receiving, in real time, over the communications network, from at least one credit bureau the credit bureau request for user authorization for each initiated credit inquiry;
determining, in real time, the user record associated with the credit bureau request for user authorization received;
displaying, in real time, on the remote computing device of the user a second GUI requesting the user approval of the initiated credit inquiry associated with the credit inquiry request for user authorization;
receiving, in real time, a plurality of second input data from the remote computing device, wherein the second input data corresponds to at least one of a credit inquiry authorization message and a credit inquiry denial message for the credit inquiry; and,
transmitting, in real time, to at least one credit bureau associated with the credit bureau request, at least one of the credit inquiry authorization message and the credit inquiry denial message.
